(19) United States
(12) Patent Application Publication
(10) Pub. No.: US 2014/0263708 A1
(43) Pub. Date: Sep. 18, 2014

(54) MULTI-SECTION APPLICATOR WITH VARIABLE-RATE SECTIONS

(71) Applicant: Ravens Industries, Inc., Sioux Falls, SD (US)

(72) Inventors: Warren L. Thompson, Baltic, SD (US); Nick Michael, Sioux Falls, SD (US); Josh Grabow, Sioux Falls, SD (US); Steve S. Jensen, Sioux Falls, SD (US); Patrick Hansen, Tea, SD (US); Jared E. Kocer, Sioux Falls, SD (US)

(73) Assignee: Ravens Industries, Inc., Sioux Falls, SD (US)

(21) Appl. No.: 13/832,735

(22) Filed: Mar. 15, 2013

(51) Int. Cl. A01C 23/00

(52) U.S. Cl. CPC A01C 23/007
USPC 239/11; 239/71

(57) ABSTRACT

This document discusses, among other things, apparatus and methods for a multi-section applicator having variable-rate sections. In an example, an apparatus can include a flow meter to provide a substance to plurality of sections, and an applicator controller including memory configured to store a coverage map of the substance. In certain examples, each section can include a metering device configured to receive a flow command and to provide a flow of the substance to a manifold using the flow command. In certain examples, the applicator controller can be configured to receive speed information and position information of the apparatus, to receive the flow rate information, to determine application rate information of the substance for each section using the speed and position information, and the coverage map, and to provide the flow command to each metering device using the application rate and flow rate information.

### BACKGROUND

Liquid applicators, such as sprayers, have assisted in distributing liquids or liquids including gas components to various objects. In certain applications, such as applying an agricultural substance to a field, an applicator can assist in applying the substance in an even manner so as to create a uniform coverage while at the same time not wasting a substantial amount of the substance. However, the resolution and capabilities of custom liquid applications is limited by the current liquid application apparatus and methods.

### OVERVIEW

This document discusses, among other things, apparatus and methods for applying liquid substances, including gaseous/liquid substances using individually adjustable distribution sections of a multi-section applicator. In an example, an apparatus can include a flow meter configured to provide flow rate information of a substance, a manifold configured to receive the substance from the flow meter and provide the substance to a plurality of distribution branches, or shanks, and an applicator controller including memory configured to store a coverage map. In certain examples, each section can include a metering device configured to receive a flow command and to provide a flow of the substance to a manifold using the flow command. In certain examples, the applicator controller can be configured to receive speed information and position information of the apparatus, to receive the flow rate information from the flow meter, to determine application rate information of the substance for each section using the speed information, the position information and the coverage map, and to provide the flow command to each metering device using the application rate information and the flow rate information.

This overview is intended to provide a general overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally a tractor with an example liquid applicator system superimposed with a custom substance coverage map.

FIG. 2 illustrates generally a block diagram architecture of an example applicator.

FIG. 3 illustrates generally an example applicator.

FIG. 4 illustrates generally an example method of operating an example applicator system.

FIG. 5 illustrates generally an example method of determining an effective orifice size of an example applicator.

### DETAILED DESCRIPTION

The present inventors have recognized methods and apparatus for simultaneously applying, releasing, or distributing a substance using a plurality of applicator sections that can control each section according to a predefined application recipe, or coverage map. In certain examples, the substance can be a liquid or a gas, or a combination of liquid and gas. This document describes the present subject matter in terms of an agricultural application of a liquid or liquid/gas, such as anhydrous ammonia (NH₃), but the subject matter is not so limited. For example, the present subject matter can be applied to other coverage application scenarios including, but not limited to, painting, industrial spray systems, coating, planters, center pivot irrigation systems, marine spraying systems, airborne spray booms, rail based sprayers and applicators, roadside sprayers with booms, mowers etc.

In certain examples, an applicator system such as a liquid application system can include a servo valve system including a valve, a servo actuator to open and close the valve, a position sensor to provide information about the position of the valve, a processor for receiving a flow command and positioning the valve using the servo actuator and the position information to provide the proper flow. In certain examples, the servo valve system can include a flow meter to provide actual flow information for positioning the valve using the servo actuator. In certain examples, the servo valve system can provide liquid to one or more nozzles and the servo valve system can include an input for receiving pressure information related to substance flow to the nozzles and can use the pressure information for positioning the valve to achieve more precise flow of the substance at the nozzles. In certain examples, pressure information can be used to calibrate the servo valve, to identify an effective orifice size of a nozzle associated with the flow of the servo valve, and to identify problems such as a plugged nozzle.

In certain examples, a liquid application system can include a main pump for providing a base flow to a nozzle distribution system. In certain examples, a controller can control the main pump using computed aggregate flow information from a GPS based coverage map. In some examples, the liquid application system can include one or more flow meters to provide actual flow information and the controller can use the actual flow information to finely adjust the operation of the main pump to more precisely provide the desired flow of liquid to the distribution system.

In certain examples, a liquid application system can include a tiered control scheme including a main pump and a plurality of distribution sections each of which can include a servo valve system supplying flow to one or more nozzles. In some examples, a liquid application system can include an applicator controller configured to interface with a field computer system or user interface system to receive GPS information, to receive custom coverage maps, to provide general flow control commands to each tier of the liquid application system and to monitor actual system operation.

In certain examples and in contrasts to existing systems, an example liquid application system can custom apply a substance using a different flow rate of the substance at each distribution section of the system. In certain examples, an agricultural liquid application system can include multiple sections with each section having multiple distribution nozzles or blades. Such a system can apply a substance according to a coverage map and can adjust flow rates of each distribution section automatically using a metering device of the distribution section, where the flow rate of a section can be based on the coverage map, and the speed and position of the applicator system.

FIG. 1 illustrates generally a self-propelled vehicle such as a tractor 100 with an example liquid applicator system 101 superimposed with a custom coverage map 103. In certain examples, the liquid applicator system 101 can include a reservoir 104 of the application liquid, feed lines 108 coupled to the reservoir 104 and to one or more sections 106. Each section 106 can supply liquid to one or more exhaust ports of a section where each exhaust port can include an orifice sized and shaped for a desired flow range. Such exhaust ports can include, but are not limited to, shanks, nozzles, blades or combinations thereof. In certain examples, the liquid applicator system 101 can include instrumentation and controls to change a dispensing rate, or an application rate, of the substance at each section 106 based on the position of the liquid applicator system 101 within the area of the custom coverage map 103. In certain examples, the instrumentation and controls can independently adjust the application rate of each section 106 using automated flow controls integrated with each section 106.

In certain examples, the liquid applicator system 101 can include an electronic version of the custom coverage map 103 in memory associated with an applicator controller. The custom coverage map 103 can include coverage information of the substance for the area within the limits of the custom coverage map 103. The custom coverage map 103 of FIG. 1 includes gradient lines 103a, 103b, 103c associated with the coverage information. In certain examples, the liquid applicator system 101 can apply a liquid or gas substance using the custom coverage map 103 and can control the application flow of an individual section 106 based on the location of the section 106 relative to the custom coverage map 103, coverage information indicated by the custom coverage map 103 for the location, and the speed of the liquid applicator system 101. In certain examples, the liquid applicator system 101 can include a frame designed to couple to the tractor 100 and can be pulled through a field. In some examples, the liquid applicator system 101 can be self-propelled.

FIG. 2 illustrates generally a bock diagram of an example applicator 201. In certain examples, the system 201 can include a reservoir 204, a flow meter 205, and a number of sections 206 (e.g., 206₁, 206₂, . . . , 206_{N}) to distribute a substance supplied by the reservoir 204, and an applicator controller 207 to control the application rate of the substance using controls of the distribution path 208 of the substance. In certain examples, the reservoir 204 can provide a supply of the substance and can include sensors 209, 210 to detect reservoir pressure and reservoir level information. In certain examples, the pressure and level information of the reservoir 204 can be communicated to the applicator controller 207 or other controllers such as a field computer 211 or user interface. In certain examples, the reservoir 204 can be directly mounted to the applicator 201. In some examples, the reservoir 204 can include a frame separate from the applicator 201 and can be coupled to the applicator 201 and towed with the applicator 201. In certain examples, power and communication can be provided using a wired 212 or wireless link to the reservoir sensors 209, 210.

In certain examples, the flow meter 205 can provide flow information to the applicator controller 207, for example, for flow control feedback, calibration, historic data collection or combinations thereof. In certain examples, the flow meter 205 can include multiple flow meters, for example, for expanding the range of flow detection of the applicator 201. In certain examples, power and communication can be provided between the flow meter and other applicator components using a wired 212 or wireless link.

In certain examples, each section 206 of the applicator 201 can receive the substance and can distribute the substance to a corresponding area of a field based on applicator and section position. In certain examples, each section, such as the first section 206₁, for example, can include a manifold 213 for distributing the substance to one of more exhaust ports, such as a shank 214 coupled to the manifold 213. In certain examples, the example section 206₁ can include an electronically adjustable metering device, such as a pump or servo valve 215 to control the flow rate of the substance to the manifold 213.

In some examples, the servo valve 215 can include a servo actuator, a valve and a servo controller. In an example, the servo controller can receive flow command information from the applicator controller 207 via a wired or wireless link 212 and can control the valve to provide the proper flow for the custom coverage. In certain examples, the valve can include, but is not limited to, a ball valve or a butterfly valve. In certain examples, the valve can range in size from about ¼ inch (in) to about 6 in., however other sizes are possible without departing from the scope of the present subject matter. In certain examples, a position sensor, such as an encoder, resolver, or potentiometer, can be coupled to the valve to provide position and/or velocity feedback of the valve to the servo controller.

In certain examples, the servo valve can include a servo actuator to move and position the valve. In some examples the actuator can receive a command signal from the servo controller and can move the valve using the command signal. The servo actuator can include, but is not limited to, a rotary actuator, a linear actuator, an electric actuator, a pneumatic actuator, a hydraulic actuator, or combinations thereof. In some examples, the servo controller can use a velocity loop to control the actuator. In some examples, the servo controller can use a torque loop to control the actuator. In certain examples, the flow control information can include a target flow rate or a valve position, and the controller can control the valve to the position corresponding to the flow command information.

In certain examples, the manifold 213 associated with the servo valve 215 can include a manifold pressure transducer 216 to provide manifold pressure information. In some examples, the manifold pressure information can provide feedback information to servo controller to control the distribution flow rate in accordance with the flow command information. In some examples, the applicator controller 207 can use the manifold pressure information to determine an effective orifice size associated with the distribution branch during an on-the-fly calibration. In certain examples, the manifold 213 can include a manifold flow meter (not shown) to provide manifold flow information to the servo controller of the servo valve 215.

In some examples, one or more exhaust ports, such as shanks 214, nozzles, or blades, coupled to the manifold 213 can include a second pressure sensor, such as a shank pressure sensor 217, to provide additional pressure information. In some examples, the additional pressure information, or shank pressure information, can be compared to the manifold pressure information or other exhaust port pressure information. Such a comparison can be used to provide an alarm when the comparison indicates that a shank is completely or partially blocked or clogged. In certain examples, a clogged shank, or a clogged nozzle, or clogged blade, can be indicated at a user interface associated with the applicator 201 or a field computer 211 when the shank pressure approaches the manifold pressure within a predetermined threshold. In some examples, an indication that the one or more exhaust ports are blocked can be provided if a difference between the manifold pressure information and the shank pressure information is within a threshold. In some examples, the indication that one or more nozzles are blocked can be provided by feedback from the section flow meters when compared to calculated section target flow rate and other section flow meters. In some examples, the comparison can be done at the applicator controller. In some examples, the comparison can be done at the servo controller. In certain examples, power and communication can be provided between the sections 206i and other applicator components, such as the applicator controller 207, using a wired 212 or wireless link.

In certain examples, the applicator 201 can include one or more optional pumps 218 to draw the substance from the reservoir 204 and supply the substance to the sections 206i. In some examples, the pump 218 can be adjustable and can be controlled by the applicator controller 207 to provide an aggregated pressure and/or flow of the substance to the sections 206i in accordance with an aggregate flow rate determined at the applicator controller 207. In some examples, the aggregate flow rate can be based on the position and speed of the applicator, the relative position of the coverage area of each of the sections 206i with respect to the custom coverage map, and the desired substance coverage associated with the relative positions of the sections 206i as provided by the custom coverage map. In certain examples, the applicator controller 207 can use the flow information from the flow meter 205 to provide feedback information to more accurately control the pump 218. In certain examples, the pump 218 can include a motor. In certain examples, a coupling 219 can connect the pump 218 with a motor on another device such as a tractor 200. The motor can include but is not limited to an electric motor, a pneumatic motor, an internal combustion engine, a hydraulic motor or combinations thereof. In certain examples, power and communication can be provided between the pump 218 and other applicator components, such as the applicator controller 207, using a wired 212 or wireless link.

In certain examples, the applicator 201 can include one or more foldable components that can hold the sections 206i. In some examples, a pump enable or flow enable valve can be coupled to the fold controls such that the flow of the substance can be disabled when the foldable components are not in position to dispense the substance.

In certain examples, the applicator controller 207 can provide control information to the various control elements of the applicator 201 and can monitor the status and operation of the applicator 201 including the status of the reservoir. In some examples, the applicator controller 207 can store parameters associated with the applicator 201 to assist with the control of the applicator 201. Such parameters can include, but are not limited to, the relative position of each of the sections 206i relative to a base position of the applicator 201, flow profiles of the servo valves 215, flow profiles of the optional pumps 218, and one or more custom coverage maps. In certain examples, the applicator controller 207 can communicate with the applicator control components and sensors using a wired 212 or a wireless communication link. In some examples, a communication interface of the applicator controller can include a control area network (CAN) bus interface.

In certain examples, the applicator controller 207 can include a global positioning system (GPS) interface to receive or assist in determining the speed and position information of the applicator 201. In certain examples, speed and position information can be received at the applicator controller 207 from a field computer 211 or user interface, such as a field computer associated with a tractor 200 pulling the applicator. In certain examples, the applicator controller can receive heading information from the GPS interface, or can determine heading information from one or more inertial sensors of the applicator 201, the tractor 200 or one or more inertial sensors of the applicator 201 and the tractor 200. In some examples, the applicator controller, can adjust the servo valves and the pump using the heading information. For example, when the applicator 201 is turning, the heading information can be used to individually adjust section flow rates to compensate for speed differences induced by the turning applicator 200. In certain examples, power and communication can be provided between the applicator 201, including the applicator controller 207, and the field computer using a wired 220 or wireless link.

In certain examples, one or more sections can include a section flow meter 223. In some examples, the servo valve 215 can include the section flow meter 220 to provide section flow information to the servo controller. In certain examples, a section flow meter 223 can allow the applicator 201 to be used in scenarios where aggregate flow of a substance is lower that the resolution of the one or more main flow meters 205. In certain examples, the applicator controller 207 can use the section flow information to control the applicator instead of, or in addition to, the aggregate flow information provided by the main flow meter 205. In certain examples, the section flow meter 223 can communicate with the applicator controller 207 and the servo controller via a wired interface 212. In certain examples, the section flow meter 223 can communicate with the applicator controller 207 and the servo controller via wireless interface.

FIG. 3 illustrates generally an example applicator 301 can include a pump 318, flow meter 305 and six applicator sections 306₁-306₆. It is understood that an example applicator 301 can employ more or less sections than the example illustrated in FIG. 3 without departing from the scope of the present subject matter. In certain examples, the applicator can include a system pressure sensor 329. In certain examples, the applicator 301 can include a reservoir 304. In certain examples, the reservoir 304, which can take the form of one or more nurse tanks, can supply one or more substances for dispensing by the applicator sections 306₁-306₆. In certain examples, the pump 318 can draw the one or more substances from the reservoir 304 and can pressurize the flow path 308 of the applicator 301. In some examples, the substance can be in both gas and liquid form within the reservoir 304. In some applications, the pump 318 can pressurize the flow path 308 of the applicator 301 to increase the liquid form of the substance in the applicator 301 which can increase the efficiency of the applicator 301 in some examples. In certain examples, the pump 318 can be powered by a tractor 300 pulling the applicator 301. In certain examples, the flow meter 305 can provide flow information to an applicator controller 307 and can be used to more precisely control the pump 318.

In certain examples, the pump 318 can provide a first tier of application rate adjustability whether the sections 306₁-306₆ include a metering device or not. In certain examples, the applicator controller 307 can receive or can compute position and speed information of the applicator 301 from GPS information received from a sensor or other system such as a field computer or user interface (not shown). In some examples, the applicator controller 307 can include an electronic version of a custom application map. The applicator controller 307 can use the custom application map and the speed and position information to compute flow rates for each of the sections 306₁-306₆. In turn, the applicator controller 307 can determine an aggregate flow rate, for example, by summing the individual flow rates of each section 306₁-306₆. The applicator controller 307 can use the aggregate flow rate to set the speed of the pump 318. As the applicator 301 moves across a field and the custom coverage map indicates a change in coverage, the applicator controller 307 can change the speed of the pump 318 to adjust the aggregate flow rate to meet the custom coverage conditions. In certain examples, pressure transducers at the stations can be used to provide pressure feedback to the applicator controller 307 so that a minimum pressure can be maintained in the system using the pump 318. Pressure control can be useful, for example, when the substance is present in the reservoir 304 in both a liquid form and a gas form. Anhydrous ammonia is one example of such a substance. In some examples, the pump can include a pump drive that can receive the flow command from the applicator controller 307 and can drive the pump using the flow command.

In certain applications, the pump 318 can include, but is not limited to, a positive displacement pump, non-positive displacement pump, centrifugal pump, piston pump, vane pump, or combination thereof. In certain examples where the substance has substantial vapor pressure, the system can use a main servo valve as described below, or other type of metering device, instead of a pump 318 to interface with the applicator controller 307 and regulate aggregate flow according to a custom coverage map. In certain examples, a flow meter 305 can be located downstream of the pump 318 and can provide flow information to an applicator controller 307 to more precisely control the pump 318.

In certain examples, each section, such as the first section 301₁, can include a metering device such as a pump or a servo valve 315, a manifold 313, a manifold pressure sensor 316, and one or more exhaust ports 314 coupled to the manifold 313. Each exhaust port 314 can include an orifice 322 for dispensing the substance. In certain examples, the servo valve 315 can include a servo controller. The servo controller can receive flow command information from the applicator controller and can position the servo valve 315 to provide flow to the manifold 313 and the exhaust ports 314 in accordance with the flow command information. In certain examples, the system and manifold pressure sensors 329, 316 can be used by either the applicator controller or the servo controller to more precisely control the flow of the substance to the manifold 313. In certain examples, an exhaust port pressure sensor 317 can be associated with one or more of the exhaust ports 314 and can be located at or near a restriction 321 of an exhaust port 314. In certain examples, the exhaust port pressure sensor 317 can monitor pressure at a restriction 321 of one or more exhaust ports 314. In certain examples, the exhaust port pressure information provided by the exhaust port pressure transducer 317 can be compared with the manifold pressure at the servo controller. If a predetermined pressure drop is not detected by the comparison of the manifold pressure and the exhaust port pressure, the comparison can indicate that an exhaust port associated with the exhaust port pressure sensor 317 is clogged or otherwise compromised. In certain examples, the exhaust port pressure information provided by the exhaust port pressure transducer 317 can be compared with other exhaust port pressure information to determine if an exhaust port 314 is clogged. In certain examples, an indication that an exhaust port 314 is clogged can be communicated to a field computer or user interface so the application of the substance can stop and the pressure anomaly can be resolved. In certain examples, the exhaust port pressure transducer 317 and the manifold pressure sensor 316 can communicate with the applicator control components, such as the applicator controller 307 or the servo valve 315 among others, using a wired or a wireless communication link 324.

In certain examples, the precise nature of the servo valves 315, the manifold pressure sensors 316, and the flow meter 305 can allow the applicator controller or the servo controller to determine an effective orifice size associated with the one or more shanks 314 associated with each of the sections 306. In certain examples, one or more sections 306 can include a section flow meter 323. In some examples, the servo valve 315 can include the section flow meter 323 to provide section flow information to the servo controller. In certain examples, a section flow meter 323 can allow the applicator 301 to be used in scenarios where aggregate flow of a substance is lower that the resolution of the one or more main flow meters 305. In certain examples, the applicator controller 307 can use the section flow information to control the applicator instead of, or in addition to, the aggregate flow information provided by the main flow meter 305. In certain examples, the section flow meter 323 can communicate with the applicator controller 307 and the servo controller via a wired interface. In certain examples, the section flow meter 323 can communicate with the applicator controller 307 and the servo controller via wireless interface 324.

FIG. 4 illustrates a flowchart of an example method 400 of applying a substance according to a custom coverage map. At 401, the method can include a receiving an electronic copy of a custom coverage map of the substance for a target area. At 402, an example applicator apparatus can be moved over the area depicted by the custom coverage map. At 403, the method can include determining an aggregate flow rate of the substance to multiple sections of the applicator using the position of the applicator and the custom coverage map. In certain examples, determining the aggregate flow and section flows can include receiving GPS data for determining or providing position and speed information of the applicator and using the speed and position information and the custom coverage map to determine the flow rates.

At 404, the method can include providing the aggregate flow of the substance from a reservoir. At 405, the method can include adjusting the flow rate of each section using a metering device of each section to provide the coverage of the substance on the area covered by the section according to the speed and position of the applicator and the custom coverage map. In certain examples, the metering device can include, but is not limited to, a servo valve, a section pump, a section flow meter, a section pressure transducer or combinations thereof,

In certain applications, the applicator controller can do most of the aggregate flow control using a pump supplying each of the sections. In such a system, if all the sections are dispensing at the same rate, all the servo valves are positioned fully open. As individual rates of the sections differ, the sections with the lower application rates are throttled using the servo valves and the overall flow rate is throttled using the pump. In certain situations, for example with a reservoir or a tank having a high vapor pressure, flow can be controlled using the servo valves and the pump can be used for aggregated flow and/or pressure control so as to maintain the substance in a true liquid form at the manifold. Such a substance would include, but not be limited to, anhydrous ammonia.

FIG. 5 illustrates generally an example method 500 of determining an effective orifice size of an example applicator. At 501, the method can include opening a section valve to a predetermined position. At 502, the method can include determining aggregate flow of a substance through the sections. In certain examples, the aggregate flow can be estimated by the pressure of the substance in the applicator flow path, or by the speed of a pump drawing the substance from a reservoir and providing the substance to each section. In certain examples, the aggregate flow can be determined using a flow meter in the applicator flow path. At 503, the method can include receiving pressure information from a manifold of a section, for example, using a manifold pressure sensor, or system pressure from a system pressure transducer. At 504, the method can include determining an effective orifice size of the section or of each nozzle in the section using the aggregate flow volume, the predetermined position of the valve, and the manifold pressure associated with the section.

### Additional Notes

In Example 1, an agricultural applicator apparatus can include a flow meter configured to provide flow rate information of a substance; a plurality of sections, and an applicator controller including memory configured to store a coverage map of the substance. In certain examples, each section of the plurality of sections can include a plurality of exhaust ports configured to release the substance, a manifold configured to distribute the substance to the plurality of exhaust ports, and a metering device configured to receive flow command information and to provide a flow of the substance to the manifold using the flow command. In certain examples, the applicator controller can be in communication with each metering device of the plurality of sections. In certain examples, the applicator controller can be configured to receive speed information and position information of the apparatus, to receive the flow rate information from the flow meter, to determine application rate information of the substance for each section using the speed information, the position information and the coverage map, and to provide a separate flow command to each metering device using the determined application rate information.

In Example 2, the metering device of Example 1 optionally includes a servo valve configured to regulate flow of the substance to the manifold, the servo valve including a valve controller configured to receive the flow command information and to position the valve using the flow command information.

In Example 3, each servo valve of any one or more of Examples 1-2 optionally includes a valve and an actuator, the actuator configured receive a command signal from the servo controller and to move the valve using the command signal.

In Example 4, the valve of any one or more of Examples 1-3 optionally includes a ball valve.

In Example 5, the valve of any one or more of Examples 1-4 optionally includes a butterfly valve.

In Example 6, the actuator of any one or more of Examples 1-5 optionally includes a linear actuator.

In Example 7, the actuator of any one or more of Examples 1-2 optionally includes a rotary actuator.

In Example 8, each servo valve of any one or more of Examples 1-7 optionally includes a position sensor configured to provide position information of the valve to the valve controller.

In Example 9, each manifold of any one or more of Examples 1-8 optionally includes a manifold pressure transducer, the manifold pressure transducer configured to provide manifold pressure information to the valve controller.

In Example 10, the apparatus of any one or more of Examples 1-9 optionally includes a pump configured to transfer the substance to the manifold.

In Example 11, the applicator controller of any one or more of Examples 1-10 optionally is configured to command each metering device to a predetermined state, to command the pump to a predetermined flow rate, and to calibrate an effective orifice size of each nozzle using the manifold pressure information, and the predetermined flow rate.

In Example 12, the applicator controller of any one or more of Examples 1-11 optionally is coupled to the valve controllers using a control area network (CAN) interface.

In Example 13, the applicator controller of any one or more of Examples 1-12 optionally is coupled to the valve controllers using a wireless interface.

In Example 14, the apparatus of any one or more of Examples 1-132 optionally includes a applicator frame configured to couple to a self-propelled vehicle, wherein the applicator controller, the manifold and the plurality of distribution branches are mounted to the applicator frame.

In Example 15, the apparatus of any one or more of Examples 1-14 optionally includes a second frame configured to couple to the self-propelled vehicle, the second frame including a reservoir configured to supply the substance.

In Example 16, each exhaust port of the plurality of exhaust ports of any one or more of Examples 1-15 optionally includes a restriction and a exhaust port pressure transducer, the exhaust port pressure transducer located at or near the restriction and configured to provide exhaust port pressure information.

In Example 17, the applicator controller of any one or more of Examples 1-16 optionally is configured to compare the exhaust port pressure information to the manifold pressure information and to provide an indication of a clogged exhaust port when the exhaust pot pressure information is within a threshold of the manifold pressure.

In Example 18, the applicator controller of any one or more of Examples 1-17 optionally is configured to receive the position information from a global positioning system (GPS) interface.

In Example 19, a method for controlling an agricultural liquid applicator can include receiving a coverage map at an applicator controller of a liquid applicator, the liquid applicator including a plurality of section, each section including one or more nozzles configured to release a substance, the coverage map including application rates of the substance corresponding to locations within the coverage map, moving the liquid applicator over the locations of the coverage map, receiving heading and position information of the liquid applicator, providing a flow of the substance to the plurality of sections; and individually adjusting individual flow rates of the substance within each of the sections of the plurality of sections using the position information of the liquid applicator, position information of each of the plurality of sections relative to the position of the liquid applicator, the heading information, and an application rate of the coverage map corresponding to the position information of each of the plurality of sections.

In Example 20, the individually adjusting individual flow rates of any one or more of Examples 1-19 optionally includes receiving a flow command from the applicator controller at a metering device of a section of the plurality of sections.

In Example 21, the individually adjusting individual flow rates includes of any one or more of Examples 1-20 optionally includes receiving a position command from the applicator controller at a servo valve of a section of the plurality of sections, and positioning the servo valve to a position corresponding to the position command.

In Example 22, The method of any one or more of Examples 1-21 optionally includes receiving, at the servo controller, manifold pressure information of a manifold coupled to the servo valve and adjusting the position of the servo valve using the manifold pressure information and the position command.

In Example 23, the method of any one or more of Examples 1-22 optionally includes receiving shank pressure information from a shank pressure transducer coupled to one or more shanks, the one or more shanks coupled to the manifold, and providing an indication that the one or more shanks are blocked if a difference between the manifold pressure information and the shank pressure information is within a threshold.

In Example 24, the positioning the servo valve of any one or more of Examples 1-23 optionally includes moving a servo actuator coupled to a valve using a servo controller.

In Example 25, the positioning the servo valve of any one or more of Examples 1-24 optionally includes receiving position feedback of the valve at the servo controller from a position sensor coupled to the valve, and adjusting the position using the position feedback and the position command.

In Example 26, the receiving a position command of any one or more of Examples 1-25 optionally includes receiving the position command from the applicator controller using a wireless network.

In Example 27, the receiving a position command of any one or more of Examples 1-26 optionally includes receiving the position command from the applicator controller using a control area network (CAN).

In Example 28, the individually adjusting individual flow rates of the substance within each of the sections of the plurality of sections of any one or more of Examples 1-27 optionally includes using an effective orifice size associated with each section, and the method of any one or more of Examples 1-27 optionally includes determining the effective orifice size of each of the plurality of sections.

In Example 29, the determining the effective orifice size of any one or more of Examples 1-28 optionally includes opening each of the plurality of servo valves to a predetermined position, determining an aggregate flow of the substance of the plurality of sections, sensing a plurality of manifold pressures from a manifold pressure sensor located in a manifold of each section of the plurality of sections; and determining the effective orifice size of a section using the aggregate flow, the predetermined position of a servo valve of the plurality of servo valves associated with the section, and a corresponding manifold pressure of the plurality of manifold pressures.

In Example 30, determining an aggregate flow of any one or more of Examples 1-29 optionally includes pumping the substance from a reservoir to the manifold of each section using a pump set at a predetermined flow rate.

In Example 31, the determining an aggregate flow of any one or more of Examples 1-30 optionally includes detecting the aggregate flow using a flow meter coupled between the reservoir and the plurality of sections.

Example 32 can include, or can optionally be combined with any portion or combination of any portions of any one or more of Examples 1 through 30 to include, subject matter that can include means for performing any one or more of the functions of Examples 1 through 30, or a machine-readable medium including instructions that, when performed by a machine, cause the machine to perform any one or more of the functions of Examples 1 through 30.

The above detailed description includes references to the accompanying drawings, which form a part of the detailed description. The drawings show, by way of illustration, specific embodiments in which the invention can be practiced. These embodiments are also referred to herein as “examples.” All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

What is claimed is:

1. An agricultural applicator apparatus comprising:
a flow meter configured to provide flow rate information of a substance;
a plurality of sections, each section including:
a plurality of exhaust ports configured to release the substance;
a manifold configured to distribute the substance to the plurality of exhaust ports; and
a metering device configured to receive flow command information and to provide a flow of the substance to the manifold using the flow command; and
an applicator controller including memory configured to store a coverage map of the substance, the applicator controller in communication with each metering device of the plurality of sections, the applicator controller configured:
to receive speed information and position information of the apparatus,
to receive the flow rate information from the flow meter,
to determine application rate information of the substance for each section using the speed information, the position information and the coverage map, and
to provide a separate flow command to each metering device using the determined application rate information.

2. The apparatus of claim 1, wherein the metering device includes a servo valve configured to regulate flow of the substance to the manifold, the servo valve including a valve controller configured to receive the flow command information and to position the valve using the flow command information.

3. The apparatus of claim 2, wherein each servo valve includes a valve and an actuator, the actuator configured receive a command signal from the servo controller and to move the valve using the command signal.

4. The apparatus of claim 3, wherein the valve includes a ball valve.

5. The apparatus of claim 3, wherein the valve includes a butterfly valve.

6. The apparatus of claim 3, wherein the actuator includes a linear actuator.

7. The apparatus of claim 3, wherein the actuator includes a rotary actuator.

8. The apparatus of claim 3, wherein each servo valve includes a position sensor configured to provide position information of the valve to the valve controller.

9. The apparatus of claim 3, wherein each manifold includes a manifold pressure transducer, the manifold pressure transducer configured to provide manifold pressure information to the valve controller.

10. The apparatus of claim 9, including a pump configured to transfer the substance to the manifold.

11. The apparatus of claim 10, wherein the applicator controller is configured to command each metering device to a predetermined state, to command the pump to a predetermined flow rate, and to calibrate an effective orifice size of each nozzle using the manifold pressure information, and the predetermined flow rate.

12. The apparatus of claim 2, wherein the applicator controller is coupled to the valve controllers using a control area network (CAN) interface.

13. The apparatus of claim 2, wherein the applicator controller is coupled to the valve controllers using a wireless interface.

14. The apparatus of claim 1, including a applicator frame configured to couple to a self-propelled vehicle, wherein the applicator controller, the manifold and the plurality of distribution branches are mounted to the applicator frame.

15. The apparatus of claim 14, including a second frame configured to couple to the self-propelled vehicle, the second frame including a reservoir configured to supply the substance.

16. The apparatus of claim 1, wherein each exhaust port of the plurality of exhaust ports includes a restriction and a exhaust port pressure transducer, the exhaust port pressure transducer located at or near the restriction and configured to provide exhaust port pressure information.

17. The apparatus of claim 16, wherein the applicator controller is configured to compare the exhaust port pressure information to the manifold pressure information and to provide an indication of a clogged exhaust port when the exhaust pot pressure information is within a threshold of the manifold pressure.

18. The apparatus of claim 1, wherein the applicator controller is configured to receive the position information from a global positioning system (GPS) interface.

19. A method for controlling an agricultural liquid applicator comprising:
receiving a coverage map at an applicator controller of a liquid applicator, the liquid applicator including a plurality of section, each section including one or more nozzles configured to release a substance, the coverage map including application rates of the substance corresponding to locations within the coverage map;
moving the liquid applicator over the locations of the coverage map;
receiving heading and position information of the liquid applicator;
providing a flow of the substance to the plurality of sections; and
individually adjusting individual flow rates of the substance within each of the sections of the plurality of sections using:
the position information of the liquid applicator,
position information of each of the plurality of sections relative to the position of the liquid applicator,
the heading information, and
an application rate of the coverage map corresponding to the position information of each of the plurality of sections.

20. The method of claim 19, wherein individually adjusting individual flow rates includes receiving a flow command from the applicator controller at a metering device of a section of the plurality of sections.

21. The method of claim 19, wherein individually adjusting individual flow rates includes receiving a position command from the applicator controller at a servo valve of a section of the plurality of sections; and
positioning the servo valve to a position corresponding to the position command.

22. The method of claim 21, including receiving, at the servo controller, manifold pressure information of a manifold coupled to the servo valve and adjusting the position of the servo valve using the manifold pressure information and the position command.

23. The method of claim 22, including receiving shank pressure information from a shank pressure transducer coupled to one or more shanks, the one or more shanks coupled to the manifold; and
providing an indication that the one or more shanks are blocked if a difference between the manifold pressure information and the shank pressure information is within a threshold.

24. The method of claim 21, wherein positioning the servo valve includes moving a servo actuator coupled to a valve using a servo controller.

25. The method of claim 24, wherein positioning the servo valve includes receiving position feedback of the valve at the servo controller from a position sensor coupled to the valve, and adjusting the position using the position feedback and the position command.

26. The method of claim 21, wherein receiving a position command includes receiving the position command from the applicator controller using a wireless network.

27. The method of claim 21, wherein receiving a position command includes receiving the position command from the applicator controller using a control area network (CAN).

28. The method of claim 21, wherein individually adjusting individual flow rates of the substance within each of the sections of the plurality of sections includes using an effective orifice size associated with each section; and
the method includes determining the effective orifice size of each of the plurality of sections.

29. The method claim 28, wherein determining the effective orifice size includes
opening each of the plurality of servo valves to a predetermined position;
determining an aggregate flow of the substance of the plurality of sections;
sensing a plurality of manifold pressures from a manifold pressure sensor located in a manifold of each section of the plurality of sections; and
determining the effective orifice size of a section using the aggregate flow, the predetermined position of a servo valve of the plurality of servo valves associated with the section, and a corresponding manifold pressure of the plurality of manifold pressures.

30. The method of claim 29, wherein determining an aggregate flow includes pumping the substance from a reservoir to the manifold of each section using a pump set at a predetermined flow rate.

31. The method of claim 30, wherein determining an aggregate flow includes detecting the aggregate flow using a flow meter coupled between the reservoir and the plurality of sections.
